(19) United States
(12) Patent Application Publication
(10) Pub. No.: US 2014/0125191 A1
(43) Pub. Date: May 8, 2014

(54) VIBRATION DAMPENING STRUCTURE FOR STEPPER MOTORS

(71) Applicant: LIN ENGINEERING, Morgan Hill, CA (US)

(72) Inventor: Ted T. Lin, Saratoga, CA (US)

(73) Assignee: LIN ENGINEERING, Morgan Hill, CA (US)

(21) Appl. No.: 13/671,360

(22) Filed: Nov. 7, 2012

(51) Int. Cl. H02K 1/18

(52) U.S. Cl. 310/216.114

(57) ABSTRACT

A stepper motor has electromagnetically driven stator segments facing corresponding rotor segments. In order to reduce vibration of the stator segments, motor body end caps are provided with a stepped annular rim along an inside diameter of a centering sleeve. The stepped rim bears against each axial end of the stator segments, with a radial dimension and an axial dimension bracketing a stator segment end in place.

### TECHNICAL FIELD

The invention relates to stepper motors and, in particular, to noise reduction in stepper motors, frequently used in robotics, appliances and industrial equipment.

### BACKGROUND ART

The problem of mechanical noise in small electrical motors is known in the prior art. In U.S. Pat. No. 5,235,227 C. Fazekas describes the problem of noise in small electrical motors used in the film industry, as well as describing prior art approaches to dampen noise, most involving use of vibration dampening material. Stepper motors have a tendency to be noisy because electrical pulses cause incremental mechanical stepping of a rotor relative to a stator of a degree or so per step. Although mechanical stepping is stop-start motion, when done at high electrical pulse frequencies it appears as smooth motion. Nevertheless, the stop-start characteristic produces noticeable noise due to rotor-stator vibration.

The rotor-stator vibration arises in stepper motors because fixed stators usually have multiple longitudinal segments with lengthwise teeth arranged around a rotating central rotor with a longitudinal axis of rotation. The stator radially surrounds corresponding longitudinal teeth in a cylinder of rotating iron, with longitudinal teeth of stator and rotor facing each other. The stator segments have electromagnets that are selectively and successively energized by an external control circuit, typically a microcontroller. To make the motor shaft turn, one electromagnet segment is powered, which causes a segment of the rotor's teeth to be magnetically attracted to a segment of the stator's electromagnet's teeth that are energized. When the segment of rotor's teeth are aligned to the corresponding segment of the electromagnet, they are slightly offset from the next electromagnet. So when the next electromagnet segment is powered on and the first is turned off, the rotor rotates slightly to align with the next electromagnet segment, and from there the process is repeated. Each of those slight rotations is called a step, with an integral number of steps making a full rotation. In that way, the motor can be turned by a precise angular amount by an exact number of steps induced by pulses to electromagnets associated with the rotor segments.

Stepper motors exhibit more noise than other motor types. One type of noise arises from stator teeth flexing and vibrating against rotor teeth, known as detent torque. Reducing detent torque by varying the pitch angles of the teeth is the most common way to reduce noise. The flexing arises because stator segments are electromagnets that move readily, vibrating under electrical impulses almost like an electromagnetic voice coil in a speaker. The electromagnet segments are typically a coil of wire wound on a plastic spool with inwardly facing teeth. Although plastic spool portions are rigidly held in place, the inwardly facing channels of the rotor will vibrate against nearby portions of the stator. In the prior art, a centering sleeve in a motor end cap has been used as a support for plastic spool edges. The centering sleeve may have a central bearing and axial aperture to support an axis of the rotor.

An object of the invention is to reduce vibration in stepper motors.

### SUMMARY OF INVENTION

The above object has been achieved in a stepper motor wherein stator segments are clamped in place by stator brackets formed in a new centering sleeve having a stepped rim. Stator segments receive electromagnetic pulses from electromagnets wound on spools near segments. The segments ordinarily mechanically behave like voice coils, moving radially inwardly and outwardly with electrical impulses, although the purpose of the electrical impulses is to provide phase offsets that drive the motor. The stepped rims of the centering sleeves in motor end caps of the present invention act like brackets overlapping both axial and radial sides of the stator segments on opposite ends of the segments. The segments are no longer free to move radially in and out, but have opposite ends held tightly in place by the stepped rims, thereby reducing vibration from this source of motor noise, without significant reduction of motor torque.

### BRIEF DESCRIPTION OF THE DRAWINGS

FIG. 1 is an exploded perspective view of a stepper motor having stepped rims associated with centering sleeves in accordance with the present invention.

FIGS. 2 and 3 are front and back perspective views of motor end caps used in the motor of FIG. 1.

FIG. 4 is a side sectional view of portions of a rotor in the stepper motor of FIG. 1.

FIG. 5 is a side sectional view of the motor of FIG. 1 in an assembled configuration.

FIG. 6 is a detail of the motor of FIG. 5 about the circle 5-5.

FIG. 7 is an enlarged side sectional view of a servo motor end cap with a centering sleeve, as in FIG. 5, but without a rotor in place.

FIG. 8 is a detail of the centering sleeve shown in FIG. 7 about the circle 7-7.

FIG. 9 is a detail of a centering sleeve of the prior art.

### DETAILED DESCRIPTION

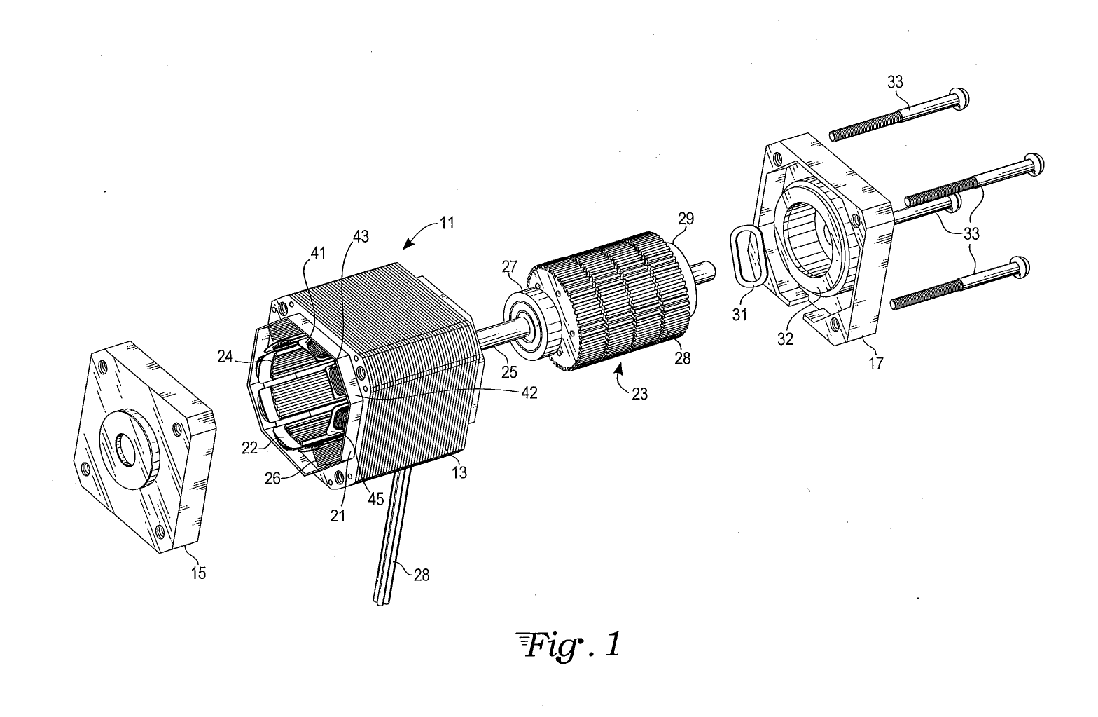

With reference to FIG. 1, stepper motor 11 has a steel body 13 that has generally planar sides truncated at corners, so that the overall configuration is octagonal. The body extends along and about a motor axis where the axis is defined by axial shaft 25 associated with rotor 23. The interior of the body has an octagonal cavity that seats the motor stator 21.

The stator 21 is segmented using spools 41, 43, 45, and so on, that seat electromagnets that are coils wound on the spools. Each spool has a radially outer shoulder and a radially inner shoulder and a spool body between the shoulders. The radially outer shoulders are formed by a unitary plastic octagon 42 adhered to the octagonal cavity of the motor body 13. Inner shoulders of each spool are circumferentially spaced stator segments joined to the outer shoulders and having a coil 26 made of multiple turns of fine wire wrapped around an interior core of the spool body for the purpose of generating a magnetic field for each stator segment with field lines extending inwardly toward the rotor axis. The wire receives electrical pulses from wires 28 that extend from the motor body. Each inner shoulder carries a piece of steel with axial or longitudinal teeth 24 forming the stator teeth. Inner spool shoulders 22 are seen to extend axially further than the steel pieces forming the stator teeth. The stator teeth face corresponding rotor teeth 28 on rotor 23. The inner spool shoulders guide a centering sleeve, such as centering sleeve 32 whereby the sleeve abuts the stator segments as described below, although the centering sleeve maintains a slight radial clearance relative to the axially extending inner shoulders. In other words, the centering sleeve fits within the inner shoulders but abuts the stator segments.

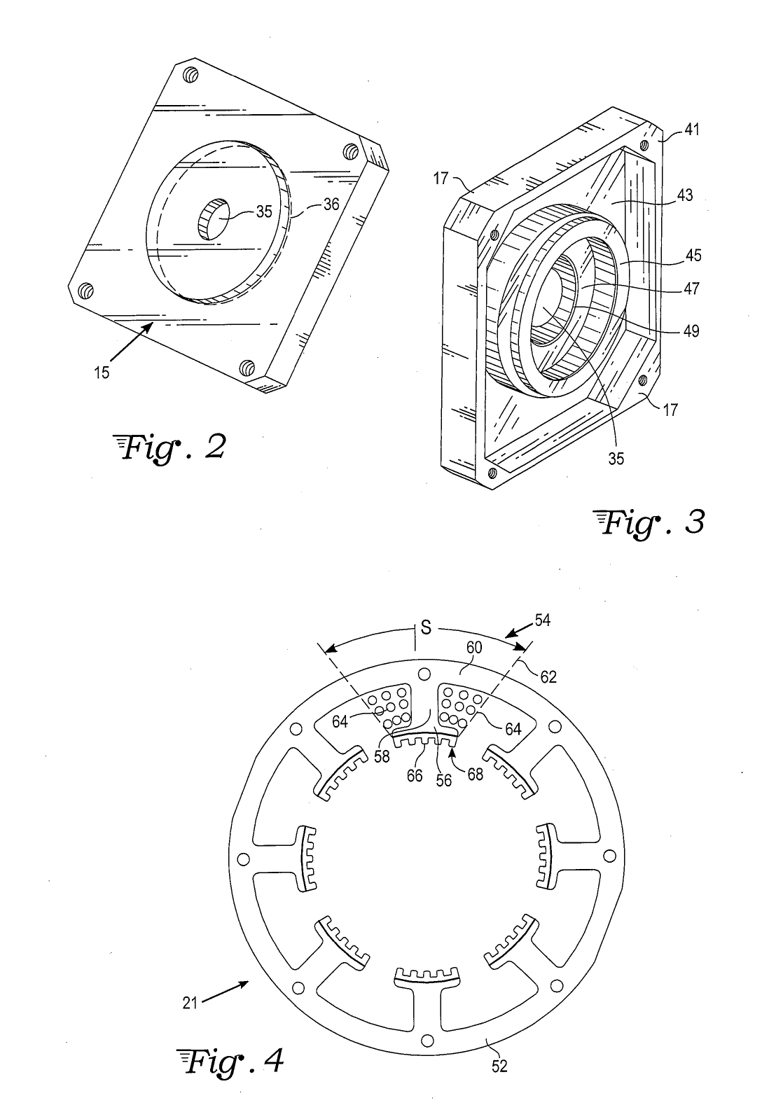

End caps 15 and 17 close the body 13 at opposed ends using screws 33 to connect the end caps through the motor body. End cap 17 is machined so that it has a unitary centering sleeve 32 projecting towards stator 21. With reference to FIGS. 2 and 3, end cap 15 is seen to have a central hole 35 for accommodating a motor axial shaft. End caps on opposite sides of the motor body are the same. An invisible outline 36 of a centering sleeve is seen in FIG. 2. With reference to FIG. 3, end cap 15 is seen having a centering sleeve 45 between a cutout region 43 and wall 41. The centering sleeve is annular, with a stepped inner rim, described below. The centering sleeve is integral with the end cap and may be machined or forged if metal, and molded if plastic. A ferromagnetic material is preferred for the end caps and the motor body in order to contain magnetic field lines and prevent electromagnetic interference. A central hole 35 supports the motor axial shaft by means of a bearing support wall 49 radially within a collar 47, a flat recessed annulus, between sleeve 45 and the hole 35. The wall 41 is octagonal in order to seat an octagonal stator as explained below.

With reference to FIG. 4 stator 21 has an outer annular rim divided into segments, such as segment 54, one of eight segments, having a radially inward shoulder 56 a spool core 58 and a radially outward shoulder 60 extending between dashed lines 62 and 64 that designate the angular extent of a stator segment. The shoulders and core define a spool supporting a number of turns of fine copper wire 64 that generate a magnetic field with field lines generally parallel to the spool, then captured by stator bar 66. The magnetic field saturates a bar of soft iron, termed a stator bar 66, a stator segment adhered to inward shoulder 56. The soft iron has a defined number of stator teeth 68 facing generally corresponding teeth in a rotor, not shown. Activation of different magnetic fields in different spools, in a precisely timed pattern, cases rotor rotation in a well known manner.

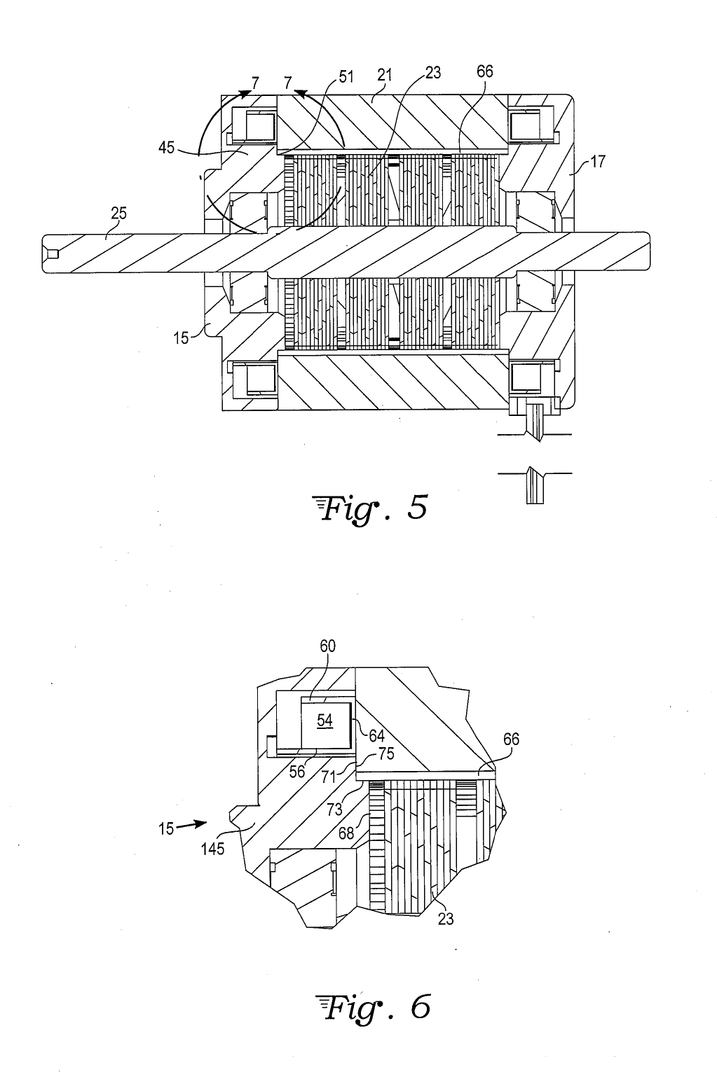

In FIG. 5 the stator 21 is seen to surround rotor 23. Axial shaft 25 is seen extending through end cap 15 and end cap 17. Centering sleeve 45 has a stepped rim 51 with a portion of the step extending axially and holding an end of stator bar 66 in place with a small amount of axial and radial contact by a stepped rim, i.e. contact in horizontal and vertical directions forming a bracket. The same structure exists at the opposite end of the rotor so that each stator bar is held in place at both ends.

In FIG. 6, the rotor 23 is shown to be in close proximity to stator bar 66 with stator teeth 68 being slightly exposed. The end cap 15 has a centering sleeve 145 with a stepped inner rim 71, the step having an axial portion 73 and a radial portion 75 supporting the axial end region of stator bar 66. A portion of the wire spool in spool 54 having a radially inward shoulder 56 and a radially outward shoulder 60. The stepped rim dampens vibration of stator bar 66 which is mechanically driven to behave vibrationally like a voice coil, although only magnetization is intended. By dampening vibration of the stator bars, noise is reduced in stepper motors.

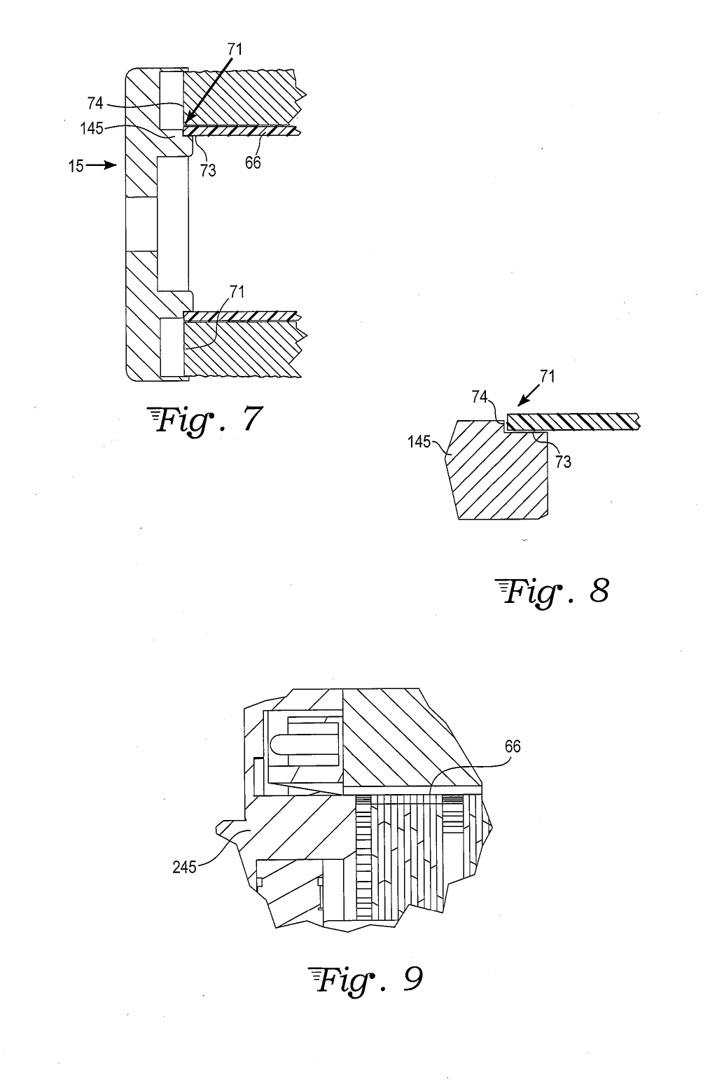

In FIG. 7 end cap 15 is again shown with centering sleeve 145 having a stepped inner rim 71. Stator bar 66 is shown to be held in place by the axial portion 73 and the radial portion 74 of a rim in the centering sleeve 145. Although the centering sleeve overlaps a small amount of the axial portion of the stator bar, blocking full stator bar magnetic linkage with the rotor, the loss of torque is thought to be negligible by the small overlap which may result in shorting of magnetic field lines from the overlap region. FIG. 8 shows the centering sleeve 145 with stepped inner rim 71 and the step with axial portion 73 and radial portion 74 retaining stator bar 66.

In FIG. 8 a centering sleeve 245 of the prior art has no stepped rim. While the centering sleeve may or may not make axial overlapping contact with stator bar 66, there is no radial contact and, consequently, the stator bar is not held firmly in place in two dimensions.

What is claimed is:

1. A stepper motor comprising:
a motor body having a longitudinal axis, with the body surrounding a fixed stator with longitudinal electromagnets arranged as toothed segments around a rotating central rotor rotating about the longitudinal axis and having corresponding longitudinally toothed electromagnet segments facing the stator segments, with longitudinally toothed segments of stator and rotor facing each other, the segmented stator segments having support extremities extending axially outwardly; and
end caps closing opposite ends of the motor body having sleeves providing centering for the stator segments, the sleeves having a radially inwardly extending annular stepped rim that makes axial and radial contact with end regions of the stator segments, holding the stator segments in place, thereby preventing ends of the stator segments from vibrating against the rotor segments.

2. The apparatus of claim 1 wherein the sleeves of the end caps are dimensioned to provide radial clearance for the support extremities of the stator segments.

3. The apparatus of claim 1 wherein the longitudinal electromagnets of the stator each have a coil wound on a spool with spool shoulders retaining the coil therebetween, one of the shoulders forming a support extremity for a stator segment.

4. The apparatus of claim 1 wherein the stator is an annular body defining a plurality of radial spools, each spool having a radial core and a radially inward shoulder, said stator segments joined to the radially inward shoulders of said radial spools.

5. The apparatus of claim 3 wherein the motor body has an octagonal interior cavity, with eight spools disposed about the octagonal interior cavity, with eight stator segments supported by eight spool shoulders.

6. The apparatus of claim 3 wherein a radially outward spool shoulder is a unitary octagonal member.

7. The apparatus of claim 6 wherein radially inward spool shoulders are segmented corresponding to said stator segments.

8. The apparatus of claim 5 wherein said motor body has an octagonal exterior surface.

9. The apparatus of claim 1 wherein said sleeves are integral with the end caps.

10. An improvement in a stepper motor comprising:
a plurality of stator segments in a motor body electromagnetically driven by coils, the stator segments having an axial dimension and capable of vibrating transversely to the axial dimension against facing rotor segments; and
a bracket retaining each axial end of a stator segment in place.

11. The apparatus of claim 10 wherein brackets at each end of a stator segment are associated with stepper motor end caps.

12. The apparatus of claim 11 wherein each end cap closes the motor body and has a centering sleeve with a stepped annular rim that makes axial and radial contact with end regions of the stator segments, holding the stator segments in place, thereby preventing ends of the stator segments from vibrating against the rotor segments.

13. The apparatus of claim 12 wherein the centering sleeve is a unitary body with the end cap.

14. An improvement in a stepper motor comprising:
a plurality of stator segments in a motor body electromagnetically driven by coils, the stator segments capable of vibrating against facing rotor segments; and
end caps closing the motor body and having a centering sleeve with a stepped annular rim that makes axial and radial contact with end regions of the stator segments, holding the stator segments in place, thereby preventing ends of the stator segments from vibrating against the rotor segments.
